(19) United States
(12) Patent Application Publication
(10) Pub. No.: US 2008/0177528 A1
(43) Pub. Date: Jul. 24, 2008

(54) Method of enabling any-directional translation of selected languages

(76) Inventor: William Drewes, Houston, TX (US)

Correspondence Address: William Drewes, Suite 1968, 14781 Memorial Drive, Houston, TX, 77079, US

(21) Appl. No.: 12/008,082

(22) Filed: Jan. 8, 2008

Related U.S. Application Data
(60) Provisional application No. 60/885,614, filed on Jan. 18, 2007.
(60) Provisional application No. 60/911,038, filed on Apr. 10, 2007.

(51) Int. Cl. G06F 17/28

(52) U.S. Cl. 704/2; 704/277

(57) ABSTRACT

A method of utilizing multiple Machine Translation “Language Pairs” to create a “Community of Language Pairs” (The Community) that consists of one “Language Pair” for every possible combination of every two languages and/or language dialects included in The Community. The present invention greatly enhances the utility of the art of Machine Translation. Utilizing the present invention, any user whose native language, or other language in which the user is fluent, which is included in The Community may now have access to machine translations of electronically recorded material produced in any other language, or language dialect, included in The Community. The present invention applies to both machine translation of material that is electronically recorded in different languages included in The Community, as well as real time interactive communication with and among multiple users whose native language, or other language in which each user is fluent, is included in The Community.

This application claims priority from provisional application Ser. No. 60/885,614, filed on Jan. 18, 2007, and provisional application Ser. No. 60/911,038, filed on Apr. 10, 2007.

### BACKGROUND OF THE INVENTION

1. Field of the Invention

The present invention advances the current state of the art of Machine Translation and provides significant utility to all possible applications of Machine Translation, including but not limited to:

1. Multi-Lingual Database Search Queries

2. Multi-Lingual Internet Search Queries

3. Machine Translation Software & Internet Services

4. Internet Chat Rooms

5. SMS (Short Message Service)

6. Voice “Auto-Translation” of Multi-Lingual Telephone calls

2. Description of Prior Art

1. Machine Translation

Automated Machine Translation automatically translates from one human written language to another. Machine Translation started with unidirectional translation between two specific languages. For example, a machine translation can translate from English to French (English-->French). Subsequently, sets of “Language Pairs” were developed for bi-directional translation functionality, such as from English to French using one “Language Pair” and from French back to English (English<->French) using a second “Language Pair”.

The use of machine translation today has become more reliable, although not on a par with professional human translation and has become commercially viable for individual, business and government use. The list of major commercial vendors of Machine Translation software vendors includes companies such as Systran, Worldlingo, SDL, Babelfish, and Intertran. Internet server based Machine Translation services are also currently provided by companies, such as Worldlingo.com.

The current state of the art is reflected in what is sold by these companies, which are, in effect, unidirectional and bidirectional sets of “language pairs”. Examples of the application of unidirectional translation include the translation of documents and web-sites from a foreign language to the user's native language, such as (English<-French). Examples of the application of bi-directional sets of “Language Pairs” include two separate “Language Pairs” for the translation of E-mails and Online Chat sessions consisting of one “Language Pair” for one direction (English->French), and a second “Language Pair” for the opposite direction (French->English). This enables a computer user to write an e-mail in English that can then be translated from the English original into French before sending the e-mail to a French speaking colleague. In turn, the same user can receive a response from the French colleague written in French, and then translate the French e-mail received into English (his/her native language) for his/her own comprehension of the response received by the user.

In each of these Machine Translation applications, the user will choose the a specific “Language Pair” indicating the source language of the text to be translated, as well as the target language, which is the language into which the source language will be translated. For example (English→French) which indicates that the source text is to be translated from English to French, or (French→English) indicating that the source text is to be translated from French to English, etc. In most Machine Translation applications, the user will choose the specific “language pair” to be used from a screen “Drop Down Menu”, containing the translation from/to “language pairs” available. As detailed above, and the user chooses the desired from/to “Language Pair” displayed within the “Drop Down Menu” by pointing and clicking with a computer mouse the desired from/to “language pair”. Although the above described technique for choosing a desired “language pair” is generally standard in the industry, the same functionality can be provided to the user by multiple other computer programming techniques known to those skilled in the art.

Thus, the current state of the art in terms of application of Machine Translation Software used for translation of electronic document text, e-mails, chat room dialogue, and Web Site Content generally involves two languages. These two languages include one “Language Pair” for translating the user's native language into a specified foreign language, and a second “Language Pair” for translating from the specified foreign language back into the user's native language.

2. Document Searching System for Multilingual Documents

U.S. Pat. No. 5,956,740, “Document searching system for multilingual documents—Nosohara Sep. 21, 1999” discloses a method for utilizing multiple Machine Translations of user specified search parameters, together with a search facility, so that a user is able to specify search query parameters once, in the user's native language, which results in multiple iterations of the search in multiple foreign languages, as well as the receipt of multi-lingual search results that are then machine translated back into the user's native language. This particular method utilizes “several iterations” of the Machine Translation process, searching in multiple languages, and translating multi-lingual search results back into the user's native language. The following is an excerpt of the first two sentences of the Abstract of said U.S. Pat. No. 5,956,740 as follows:

“The present invention provides a system, which enables searching documents at one time, even if they may be written in plural languages, according to key words written in the searcher's language. The system also enables translation of the search results into the searcher's language prior to being displayed.”

U.S. Pat. No. 6,212,537, “Document searching system for multilingual documents—Nosohara Apr. 3, 2001” is a continuation of application Ser. No. 08/740,044, filed Oct. 23, 1996 now U.S. Pat. No. 5,956,740 (See: above).

3. Database Search Facilities

Specific Databases provide specific Query Languages (e.g. SQL Query) that enable users to specify criteria for locating record(s) in the Database. Such user-supplied criteria can consist of a user supplied text string that is compared to fields on each record on the database for a match. This, followed by Boolean searches, enables the user to specify two or more text content strings and provide user selected relationship attributes between these text content strings, such as “And”, “Or” and “And Not”. Each user supplied text string can be compared to different database record fields according to a drop down menus that enable the user to select a database record field to which the user supplied text string is to be compared in order to locate specific records on the database. An example of such a Boolean Query Facility is the USPTO.gov Patent Database Quick Search facility (See: www.uspto.gov Patent Search).

Over time, more and more selection possibilities, such as data ranges, etc., were added and the Data Base Query languages changed from language format to preformatted Search Screens. As a result, the “Look & Feel” of the Database Query became essentially the same as that of Internet Search Engines or Internet Database Dictionaries (see: below). Today, the only difference is the underlying technology, which is transparent to the user.

4. Internet Search Engines

As tool for finding information on the Internet, most search engines consist of the following main components:

1. Spider

2. Indexer

3. Database

4. Search software

5. Web interface

Documents found by the spider are processed by the indexer and stored in a database. From the database, the search software extracts documents based on parameters entered by the user. Examples of search engines include Google and AllTheWeb. The details of how search engines work are discussed in more detail in the Search Engine Yearbook.

5. Internet Directory Databases

This is a categorized collection of links to the web, which is usually compiled manually. Directories can either be general (to the entire web) like ODP or topical like the Dotcom Directory. Although they cannot rival search engines for index size, they generally do offer higher quality search results, arrived at through some editorial selection process. Directories like Yahoo and ODP are often referred to as search engines although they are not.

6. Computer or Mobile Device “Chat Room” Technology

Common Public Domain Knowledge, which is self-explanatory.

7. Mobile Device Instant SMS Messaging Technology

Common Public Domain Knowledge, which is self-explanatory.

8. Voice Recognition Technology

Voice Recognition allows a user to use his/her voice as an input device. Voice recognition may be used to dictate text into the computer or to give commands to the computer (such as opening application programs, pulling down menus, or saving work).

Older voice recognition applications require each word to be separated by a distinct space. This allows the machine to determine where one word begins and the next stops. This style of dictation is called discrete speech. Many people (especially those with learning disabilities) prefer these systems to the newer continuous speech.

Continuous speech voice recognition applications allow a user to dictate text fluently into the computer. These new applications can recognize speech at up to 160 words per minute. While these systems do give the user system control they are not yet hands-free.

Voice recognition uses a neural net to “learn” to recognize the individual's voice. As the person speaks, the voice recognition software remembers the way each word is said. This customization allows individualized voice recognition, significantly increasing accuracy for each individual user, even though everyone speaks with varying accents and inflection.

In addition to learning how you pronounce words voice recognition also uses grammatical context and frequency of use to predict the word you wish to input. These powerful statistical tools allow the software to cut down the massive language data base before you even speak the next word.

An example of the advanced level already achieved by Voice Recognition technology is IBM's Embedded ViaVoice 4.4 product. On Jan. 24, 2006 IBM unveiled this new speech recognition technology that can comprehend the nuances of spoken English, translate it on the fly, and even create on-the-fly subtitles for foreign-language television programs.

VoiceXML is to be the standard with which voice applications are developed on the Internet. It will be created by combining several mark-up languages that already exist, which are based on the XML standard.

Major vendors in the Voice Recognition technology field include IBM, Scansoft, Kolvox, Command Corps Inc. and Next Generation Technologies.

9. Speech Synthesis

Speech synthesis is the artificial production of human speech. A computer system used for this purpose is called a speech synthesizer, and can be implemented in software or hardware. A text-to-speech (TTS) system converts normal language text into speech; other systems render symbolic linguistic representations like phonetic transcriptions into speech. The applications of the present invention disclosed herein utilize text-to-speech (TTS) voice synthesis.

Synthesized speech can also be created by concatenating pieces of recorded speech that are stored in a database. Systems differ in the size of the stored speech units; a system that stores phones or diaphones provides the largest output range, but may lack clarity. For specific usage domains, the storage of entire words or sentences allows for high-quality output. Alternatively, a synthesizer can incorporate a model of the vocal tract and other human voice characteristics to create a completely “synthetic” voice output.

The quality of a speech synthesizer is judged by its similarity to the human voice, and by its ability to be understood. An intelligible text-to-speech program allows people with visual impairments or reading disabilities to listen to written works on a home computer. Many computer operating systems have included speech synthesizers since the early 1980s. The quality of speech synthesis technology has improved over the years to the point that synthesized voice messages are often included in computer applications in place of written text messages. For example, recently, web sites such as Bluemountain.com have featured ecards that allow a user to produce custom-made vocal greetings from a computer-generated voice. These ecards usually consist of pre-made images, but some allow the user to select an image of whatever the user wants. All of the ecards allow the user to select the computer's vocabulary.

A number of mark-up languages have been established for the rendition of text as speech in an XML-compliant format. The most recent is Speech Synthesis Markup Language (SSML), which became a W3C recommendation in 2004. Older speech synthesis markup languages include Java Speech Markup Language (JSML) and SABLE. Although each of these was proposed as a standard, although none of them has been widely adopted.

Speech synthesis markup languages are distinguished from dialogue markup languages. VoiceXML, for example, includes tags related to speech recognition, dialogue management and touchtone dialing, in addition to text-to-speech markup.

Major vendors in the Voice Synthesis technology field include IBM, Apple, AmigaOS, and Microsoft.

### SUMMARY OF THE INVENTION

The present invention utilizes multiple Machine Translation “Language Pairs” to create a “Community of Language Pairs” (The Community) that consists of one “Language Pair” for every possible translation direction combination of every two languages and/or language dialects included in The Community. For best results, “language pairs” should be dialect specific in nature, so that different dialects of a language would be considered different languages.

Mathematically, the total number of separate individual “Language Pairs” (t) required to construct a “Community of Language Pairs” (The Community) consisting of one “Language Pair” for every possible combination of every two languages and/or language dialects included in “The Community”, is calculated as follows:

Definitions
(t)=The total number of separate individual “Language Pairs” required to construct a specific “Community of Language Pairs” (The Community).
(n)=The total number of different languages included in the “Community of Language Pairs”.

Equation:

t=[n*(n−1)]

For example, let us take the case of an American English user who requires unfettered communication with and among all other users utilizing three foreign languages (for example, French, German, and Russian).

Using the above equation, with the above four languages, then twelve (12) individual unidirectional “Language Pairs”, will be required. The following describe this example.

Definitions

(n)=4

Equation

t=[4*(4−1)]=12

Uni-Directional Language Pairs

### EXAMPLES

### Four Languages in the “Community of Language Pairs”

1. (American English→French)
2. (American English→German)
3. (American English→Russian)
4. (French→American English)
5. (French→German)
6. (French→Russian)
7. (German→French)
8. (German→American English)
9. (German→Russian)
10. (Russian→French)
11. (Russian→American English)
12. (Russian→German)

The above 12 unidirectional language pairs can also be expressed as six (6) bidirectional language pairs as follows:
1. (American English [symbol] French)
2. (American English [symbol] German)
3. (American English [symbol] Russian)
4. (French [symbol] German)
5. (French [symbol] Russian)
6. (Russian [symbol] German)

The present invention greatly enhances the utility of the art of Machine Translation. Utilizing the present invention, any user whose native language, or other language in which the user is fluent, is included in The Community, may now have access to machine translations of electronically recorded material written in any other language or language dialect that is included in The Community.

The present invention applies to both machine translation of material that is electronically recorded in different languages included in The Community, as well as real time interactive communication with and among multiple users whose native language, or other language in which each user is fluent, is included in The Community. Depending on the specific Machine Translation application or implementation, the said translation may be either or both written translation and/or voice synthesized translation.

Given the current state of the art of Machine Translation, the user base of machine translation software consists largely of users who have a perceived need for said machine translation software. Said perceived need on the part of users must be adequate in order to motivate the said users to pay the purchase price for those specific language pairs for which said users perceive the said need. As a result, the current user base for machine translation software consists largely of individual users, corporations, academic institutions, and government entities.

It is anticipated that the present invention will, to some extent, motivate technology content and/or communication providers to incorporate the inclusive “Community of Language Pairs” Machine Translation capabilities as part of their current offerings. This will be due to the financial motivation of said providers to increase and expand the user base of their particular technology content and/or communication offering to include new users whose native language is included in the “Community of Language Pairs” employed by said providers. Said use by said providers will also be due competitive need of businesses to differentiate themselves from their competition. In turn, it is anticipated that market forces will lead to the financial incentive to invest in the development of additional “Language Pairs” in order to meet market demand. As a result, all should benefit including said providers, the user bases of said providers, as well as the market for and investment in Machine Translation software.

The present invention is used to construct an inclusive “Community of Language Pairs” (The Community) to effect any-directional machine translation of all languages included in The Community. It is understood that a “Community of Language Pairs” may also include extraneous “Language Pairs” that are not included in the community, but considered necessary or beneficial by said user and/or said provider. In this case, the term “Community of Language Pairs” and the claims of the present invention related thereto refer only to the group of language pairs included in The Community, in accordance with the above disclosed construction and definition of “Community of Language Pairs”.

As a result, the present invention will greatly reduce the language barriers inherent in all current and future applications of the art of Machine Translation, including, but not limited to:
1. Multi-Lingual Database Search Queries
2. Multi-Lingual Internet Search Queries
3. Machine Translation Software & Internet Services
4. Internet Chat Rooms
5. SMS (Short Message Service)
6. Voice “Auto-Translation” of Multi-Lingual Telephone calls

### BRIEF DESCRIPTION OF THE DRAWINGS

FIG. 1 is a diagram illustrating the “Community of Language Pairs” showing four (4) sample languages selected for the community that result in bidirectional language pairs for the selected languages enabling users each with a “language preference” for one of said sample languages selected for the community to receive translations in every language included in the community, as well as to enable respective user(s) to provide input for translation in their own respective “language of preference”.

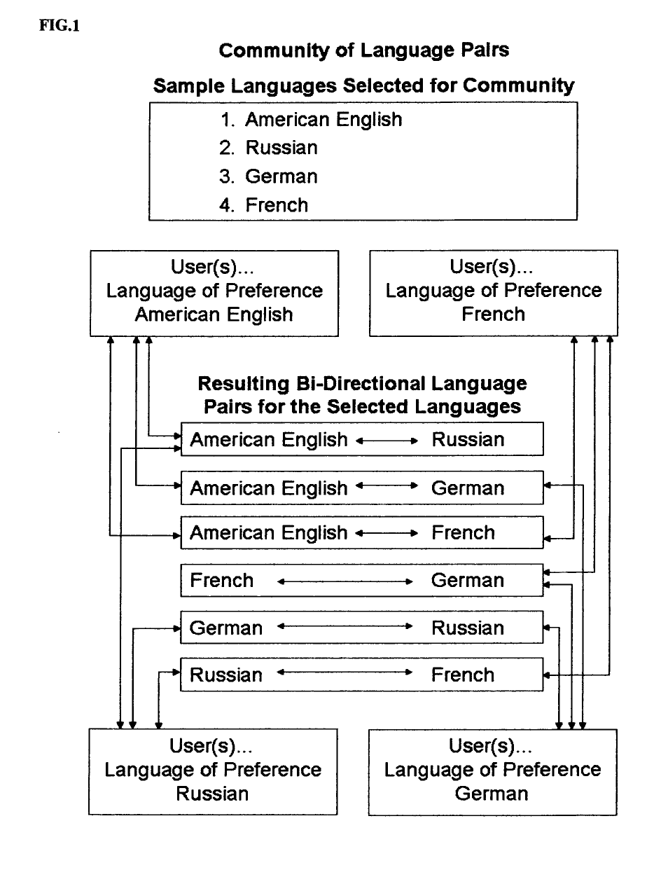

### DETAILED DESCRIPTION OF THE INVENTION

General

According to the current state of the art of Machine Translation applications, the user will generally choose a specific “language pair” indicating the source language of the text to be translated, as well as the target language, which is the language into which the source language will be translated. For example (English→French), which indicates that the source text is to be translated from English to French, or (French→English), which indicates that the source text is to be translated from French to English, etc. In most Machine Translation applications, the user will choose the specific “language pair” to be used from a screen “Drop Down Menu”, containing the translation from/to “language pairs” available. As detailed above, and the user chooses the desired from/to “language pair” displayed within the “Drop Down Menu” by pointing and clicking (with a computer mouse) the desired from/to “language pair”. Although the above described technique for choosing a desired “language pair” is generally standard in the industry, the same functionality can be provided to the user by multiple other computer programming techniques known to those skilled in the art.

Thus, the current state of the art in terms of application of Machine Translation Software for translation of electronic text, e-mails, chat room dialogue, and Web Site Content generally involves two languages (One Unidirectional “Language Pair”) for any single iteration of a Machine Translation process.

Utilizing the present invention, the above described “Drop Down Menu” method by which the user selects the language pair and translation direction required, is no longer necessary or desirable. Utilizing the present invention, any user whose native language, or preferred communication language is included in the community, will have access to machine translations of electronically recorded material written in any other language or language dialect that is included in The Community. Therefore, utilizing the present invention, all that the Machine Translation application needs to know is the user's native language, or preferred communication language, in which the user chooses to view machine translation results, regardless of the language of origin.

As a result, utilizing the present invention, a mechanism for allowing the user to inform the particular Machine Translation application of the user's native language, or “preferred communication language” (Interface Language), is required by each application of the present invention, including the below detailed Applications of the Present Invention. By way of example, said user process of informing an application provider, who utilizes the present invention, of the user's preferred communication language, can easily be accomplished by the user through Internet access to the user's personal account within the application provider's web site.

In the case where the particular Machine Translation application is installed on and primarily intended for use on single user stand-alone computing device(s), the application will provide the user with the capability to indicate the user's native language, or preferred communication language to the particular Machine Translation application. The machine Translation application will record the user's language preference, but will allow the user to subsequently change said preference.

The particular Machine Translation application may also reside on a network server, or other server environment including but not limited to a private network server, public network server, a server within the Internet (World Wide Web), database provider server, telecommunications provider server, 3G or other communications or content provider server. In such cases, the said server application will provide the user with the capability to indicate the user's native language, or preferred communication language to the particular Machine Translation application. Also, in the case of database providers, telecommunications providers, 3G mobile or stationary communications or content, database or other information providers, an Internet web site may be made available by the particular provider to enable the user to view and modify account information. It would be beneficial for said provider(s) web site(s) may also provide the user with the capability to initially choose and subsequently modify the user's native language, or preferred communication language to the particular provider's Machine Translation application.

The above techniques for the user to specify their choice of Interface Language to the Machine Translation application should be considered preferred embodiments for indicating and recording the users Interface Language to a Machine Translation application. It is both implied and understood that other such techniques for accomplishing the same functionality may be employed by those skilled in the art.

The machine translation process employed with the present invention may include multi-lingual “Industry Specific Technical” dictionaries, each such dictionary including industry specific terms for industries and professions, such as Engineering, Medicine, Telecommunications, Defense, etc., in order to correctly translate industry specific professional or industry specific terms. In such a case, the user will have the option to specify the specific industry dictionary that will be employed in the search parameter translation process.

The machine translation process employed with the present invention also includes a “Do Not Translate” dictionary for terms that may have meanings in other language(s) included in the “Language Pairs”, but should be left as is, and not be translated. For example, the term “Las Vegas” is the name of a place, which in Spanish, without a “Do Not Translate” option would be translated to “the fertile valleys”, and therefore should not be translated. The user may have the option to add, delete words and terms from the “Do Not Translate” dictionary.

The “Language Pairs” employed for the present invention should be dialectic in nature so that one language, such as English, is to be considered multiple languages for the purpose of machine translation of each dialect of each language. Therefore, separate and distinct “Language Pairs” one for each such dialect of a specific language will be used. This approach will ensure a more accurate and relevant machine translation. For example, the separate and distinct languages that make up different “language pairs” relating to the general category of English would include different “language pairs” that include American English, UK English, Australian English, South African English, etc.

Using a button displayed on the page, or via any other method known to those skilled in the art, the user may choose to view the current page in its original language. Also, since, as previously mentioned, machine-translated documents, given the current state of the art, cannot be relied upon as an official or authoritative translation, the capability to request a professional human translation of a specified document would be beneficial. Therefore, a second button, or other method known to those skilled in the art, would be employed to enable the user to request a professional human translation. As a commercial matter, a translation price quote and turn-around time for professional human translation of the particular document may be displayed for the user's approval and authorization. Of course, the user may choose not to accept the proposed translation price quote and/or turn-around time for said proposed professional human translation.

The present invention applies to both machine translation of material that is electronically recorded in different languages included in The Community, as well as real time interactive communication with and among multiple users whose native language, or other language in which each user is fluent, is included in The Community.

The input to the Machine Translation process is electronically recorded text recorded in any language included in the “Community of Language Pairs” employed by any or all of the below detailed applications of the present invention.

Depending upon the specific Machine Translation application or implementation, the said electronically recorded text may originate as human voice that is transformed into electronically recorded text by means of Voice Recognition technology.

The output from the Machine Translation process is electronically recorded text recorded in any language included in the “Community of Language Pairs” employed by any or all of the below detailed applications of the present invention. Depending upon the specific Machine Translation application or implementation, the said electronically recorded text may be transformed to synthesized human speech by means of text-to-speech (TTS) voice synthesis technology.

### APPLICATIONS OF THE PRESENT INVENTION

The present invention is intended for incorporation into currently available and future technological applications, including, but not limited to the technology applications detailed below:

1. Multi-Lingual Database Search Queries

Databases may be stand-alone, or be available on private entity networks (e.g., corporate Intranets, LAN, WAN, etc.), and/or available on individual Web Sites on the World Wide Web (Internet) by use of the present invention. In many cases, Database access is protected by a User ID and/or Password scheme. Such a User ID and/or Password access control scheme is often used to facilitate a commercial “for profit” subscription or license fee business model.

Many databases include general news and/or profession specific articles in different languages that reside, in fact, either on different databases or in different language specific sections of the same physical database. Other than general news and news archives that can be used for business intelligence purposes, such databases are often profession specific in that, although they contain data or articles in different languages, they all apply to a single subject. These subject specific databases, with data and/or articles provided in different languages, may be specific to such professional subjects as medicine, engineering, religion, aerospace, law, defense, etc. The problem is that people fluent in a single language, such as English, are not able to benefit by reading and comprehending data and/or articles available in the database that are written in foreign languages, which they can neither read not understand.

Using the present invention, Community, it would be most beneficial for all people fluent in any language included in The Community. These people would be able to read and comprehend machine-translated data, information, articles, etc. in all other languages included in The Community.

This Database search query parameters are specified by the user in the user's “preferred communication language”, and the translated results of the query are presented to the user in the user's “preferred communication language”.

By way of example, in this manner, physicians fluent in English would benefit by being able to read and comprehend medical articles written in several foreign languages using what “appears to the user” to be only one single user iteration of an Database Search Query.

Thus, the utility of a database consisting of data in multiple languages would be greatly enhanced by use of the present invention. This is due to the fact that utilizing the present invention, any person fluent in any of the languages included in the included in the “Community of Language Pairs” would be able to read and comprehend in their own “preferred communication language”, all other languages included in the “Community of Language Pairs” provided by the database.

For commercial purposes, this method would greatly expand the potential for a paying user subscriber-base to a particular database that would include all users fluent in any language that is included in the “Community of Language Pairs” employed by the provider of the database.

It should be noted that with the present invention “The Community of Language Pairs” employed by the provider of a database using the present invention may consist of many more languages that the actual number of different languages included in the database. The same is true even in the case that the database consists of data or articles or other information in only one single language. In these cases, the number of potential users of the database will be dramatically expanded.

In the above described use of the present invention, when a specific Search Result entry is chosen (e.g., by mouse click or other means) by the user, a machine-translated page of the selected information is displayed. All pages of the search results the user displayed, which the user then chooses to view are also machine-translated, as follows. Since machine translation is a process that requires computer CPU cycles and other time consuming computer resources, the machine translation may be limited to only one, or a few pages at a time, prior to user viewing. In such a manner, the current page that the user is viewing is machine-translated, without any significant degradation of either computer response time or overall computer performance.

Using a button displayed on the page, or via any other method known to those skilled in the art, the user may choose to view the current page in its original language. Also, since, as previously mentioned, machine-translated documents, given the current state of the art, cannot be relied upon as an official or authoritative translation, the capability to request a professional human translation of a specified document would be beneficial. Therefore, a second button, or other method known to those skilled in the art, would be employed to enable the user to request a professional human translation. As a commercial matter, a translation price quote and turn-around time for professional human translation of the particular document may be displayed for the user's approval and authorization. Of course, the user may choose not to accept the proposed translation price quote and/or turn-around time for said proposed professional human translation.

2. Multi-Lingual Internet Search Queries

While different tools used to search the Internet tend to have the same “Look & Feel”, they differ in terms of their underlying technologies.

The excerpt below from the “Field of Invention” section of U.S. Pat. No. 6,604,101 “Method and system for translingual translation of query and search and retrieval of multilingual information on a computer network” details and explains the different tools used to search the Internet and their respective technologies as follows.

“Search tools of different kinds fall broadly into five categories, which are as follows:

1. directories; 2. search engines; 3. super engines; 4. meta search engines; and 5. special search engines.
Search tools like Yahoo, Magellan and Look Smart qualify as web directories. Each of these web directories has developed its own database comprising of selected web sites. Thus, when a user uses a directory like Yahoo to perform a search, he/she is searching the database maintained by Yahoo and browsing its contents.
Search engines like Infoseek, Webcrawler and Lycos use software such as “spiders” and “robots” that crawl around the Web and index, and catalogue the contents from different web sites into the database of the search engine itself.
A more sophisticated class of search engines includes super engines, which use a similar kind of software as “robots” and “spiders. “However, they are different from ordinary search engines because they index keywords appearing not only on the title but anywhere in the text of a site content. Hot Bot and Altavista are examples of super engines.
Search engines further include meta search engines, which consist of several search engines. A user using a meta search engine actually browses through a whole set of search engines contained in the database of the meta search engine. Dogpile and Savvy Search are examples of meta search engines.
Special search engines are another type of search engines that cater to the needs of users seeking information on particular subject areas. Deja News and Infospace are examples of special search engines.”

For the purpose of disclosing the present invention, all of the above excerpted, different tools used to search the Internet will be referred to below using the general term “Internet Search Query”, unless the name of a specific technology or tool is specified, as detailed in the above excerpt.

Today, the Internet is a public, interactive, and self-sustaining community accessible to hundreds of millions of people worldwide and growing fast. The Internet is, in effect, a world community, in which Web Sites, information and data concerning almost any conceivable subject, idea or opinion is readily available to all users. The only barrier left to a community-wide exchange of ideas and information is that of language. The problem is that people fluent in a single language, such as English, are not able to benefit by reading and comprehending data, ideas or information that are freely available on the Internet, but written in foreign languages, which they can neither read not understand.

Using the present invention, Community, it would be most beneficial for all people fluent in any language included in The Community. These people would be able to read and comprehend machine-translated data, information, articles, etc. in all other languages included in The Community.

This Internet search query parameters are specified by the user in the user's “preferred communication language”, and the translated results of the query are presented to the user in the user's “preferred communication language”.

By way of example, in this manner, physicians fluent in English would benefit by being able to read and comprehend medical articles written in several foreign languages using what “appears to the user” to be only one single user iteration of an Internet Search Query.

Thus, the utility of the Internet, consisting of data in multiple languages would be greatly enhanced by use of the present invention. This is due to the fact that utilizing the present invention, any person fluent in any of the languages included in the included in the “Community of Language Pairs” would be able to read and comprehend in their own “preferred communication language”, all other languages included in the “Community of Language Pairs”.

For commercial purposes, this method would greatly expand the potential user-base for a provider of an Internet Search Query facility to include all people fluent in any language that is included in the “Community of Language Pairs” employed by the Internet Search Query facility.

In the above described use of the present invention, when a specific Search Results entry is chosen (e.g., mouse clicked, etc.) by the user, a machine-translated page of the selected information is displayed. All pages of the search results the user displayed, which the user then chooses to view, are also machine-translated, as follows. Since machine translation is a process that requires computer CPU cycles and other time consuming computer resources, machine translation may be limited to only one, or a few pages at a time, prior to user viewing. In such a manner, the current page that the user is viewing is machine-translated, without any significant degradation of either computer response time or overall computer performance.

Using a button displayed on the page, or via any other method known to those skilled in the art, the user may choose to view the current page in its original language. Also, since, as previously mentioned, machine-translated documents, given the current state of the art, cannot be relied upon as an official or authoritative translation, the capability to request a professional human translation of a specified document would be beneficial. Therefore, a second button, or other method known to those skilled in the art, would be employed to enable the user to request a professional human translation. As a commercial matter, a translation price quote and turn-around time for professional human translation of the particular document may be displayed for the user's approval and authorization. Of course, the user may choose not to accept the proposed translation price quote and/or turn-around time for said proposed professional human translation.

3. Machine Translation Software & Internet Services

Providers of Machine Translation Software, sold either in packaged form, or as an Internet Web service, for the translation of written text, in any form, including Documents, E-Mails, and Internet Site contents, would greatly benefit from the present invention. Internet Web translation services can be used on either a static device with an Internet connection, such as a PC, or a mobile communications device connected to the Internet, such as a 3G Mobile Phone, or other mobile interactive communications device. The technology currently exists so that in the future such Machine Translation will also be able to utilize voice synthesis that may be incorporated into this technology.

4. Internet Chat Rooms

Internet Chat Rooms are applications that enable large numbers of users interactively communicate in real time. Currently in such Chat Rooms users communicate in written text. The present invention would eliminate the language barrier that currently inhibits Chat Room communication between users with different native languages, and would expand Chat Room use across different nations throughout the world. The technology currently exists so that in the future such Chat Rooms will also be able to utilize voice recognition and voice synthesis that may be incorporated into this technology.

5. SMS (Short Message Service)

SMS, also known as IM (Instant Messaging), is an interactive text messaging service available on most Mobile Phones. The service does not utilize the Internet, but rather the text message is initiated and transmitted within the communications server network of one communications provider. If necessary, further transmission across the networks of multiple world-wide communications provider networks is commonly provided for the message to reach an SMS user located within the service area of a different communication provider's network. The present invention would eliminate the language barrier that currently inhibits SMS communication between users with different native languages and would expand SMS/Chat use across different nations throughout the world. Voice synthesis is already employed with SMS technology by communication providers in order to deliver SMS messages to the recipient through an automated telephone call to the recipient. In the future, the use of voice synthesis together with SMS technology may expand in such a way that users will interactively hear voice synthesized SMS messages that they have received in text format.

6. Voice “Auto-Translation” of Multi-Lingual Telephone Calls Between Two or More Participants

Telephone conversations, between two or more participants, utilizing either wireline, mobile wireless telephone devices through telephony networks or VOIP enable voice communications between people regardless of geographic location of the participants. Telephony voice communication is so common; it is taken for granted as a natural part of everyday life, by people throughout the world. The present invention will significantly eliminate the language barriers that currently inhibit voice telephony communication between people who speak different native languages, and, as a result, would greatly expand telephony voice utilization and thus every day communications between peoples across different nations throughout the world.

As with all “Community of Language Pairs” applications, each user would inform the Communications Provider of the user's native language, or preferred language for communication, in which the user chooses to both talk as well as hear responses during the “auto-translate” telephone conversation. By way of example, said user process of informing the Communications Provider of such preferences, can be accomplished by the user through Internet access to the user's personal account within the Communications Provider's web site.

When a participant in an automated Machine Translation conversation talks, the Voice Recognition technology will convert the participant's spoken words into electronically recorded text. Machine Translation would then convert (translate) the electronically recorded text of the speaker into the respective language(s) of each participant in the “auto-translate” telephone conversation. The said translated text, in the respective language(s) of each telephone conversation participant, would then be transformed to synthesized human speech by means of text-to-speech (TTS) voice synthesis technology. Said voice synthesis communication would then be transmitted to each respective “auto-translate” telephone conversation participant in their own respective chosen language.

The trigger to initiate the above detailed human voice synthesis text-to-speech (TTS) delivery process to other respective participant in their own chosen language, could be a pause for a specified number of seconds. Alternatively said trigger mechanism can be the pressing of a specific telephone pad key such as the star key, or any other method that is found to be convenient for the user and known to those skilled in the art.

Each participating user may also choose certain characteristics of the voice synthesis to be used for them, such as male, female, human age, etc. Optionally, a user may choose that the other “auto-translate” telephone conversation participants hear their own spoken voice in their own original language, prior to the delivery of the translated voice synthesis communication to each respective participant.

### REFERENCE CITED

(1)—U.S. Patent Documents

U.S. Pat. No. 5,148,541 Multilingual database system including sorting data using a master universal sort order for all languages—Lee , et al. Sep. 15, 1992

U.S. Pat. No. 5,278,980 Iterative technique for phrase query formation and an information retrieval system employing same—Pedersen, et al. Jan. 11, 1994

U.S. Pat. No. 5,708,825 Automatic summary page creation and hyperlink generation—Sotomayor Jan. 13, 1998

U.S. Pat. No. 6,952,691 Method and system for searching a multi-lingual database—Drissi, et al. Oct. 4, 2005

U.S. Pat. No. 6,604,101 Method and system for translingual translation of query and search and retrieval of multilingual information on a computer network—Chan, et al. Aug. 5, 2003

U.S. Pat. No. 6,542,888 Content filtering for electronic documents generated in multiple foreign languages—Marques Apr. 1, 2003

U.S. Pat. No. 6,418,402 Method and system for utilizing machine translation as input correction—King, et al. Jul. 9, 2002

U.S. Pat. No. 6,389,387 Method and apparatus for multi-language indexing—Poznanski, et al. May 14, 2002

U.S. Pat. No. 6,360,196 Method of and apparatus for retrieving information and storage medium—Poznanski, et al. Mar. 19, 2002

U.S. Pat. No. 6,349,276 Multilingual information retrieval with a transfer corpus—McCarley Feb. 19, 2002

U.S. Pat. No. 6,346,990 Method of selecting a character from a plurality of code character conversion tables—Watanabe, et al. Feb. 12, 2002

U.S. Pat. No. 6,212,537 Document searching system for multilingual documents—Nosohara Apr. 3, 2001

U.S. Pat. No. 5,956,740 Document searching system for multilingual documents—Nosohara Sep. 21, 1999

U.S. Pat. No. 6,604,101 Method and system for translingual translation of query and search and retrieval of multilingual information on a computer network—Chan, et al. Aug. 5, 2003

U.S. Pat. No. 7,089,559 Method, apparatus, and program for chaining server applications—Redpath Aug. 8, 2006

U.S. Pat. No. 7,024,407 Word sense disambiguation—Bradford Apr. 4, 2006

U.S. Pat. No. 6,999,916 Method and apparatus for integrated, user-directed web site text translation—Lin, et al. Feb. 14, 2006

U.S. Pat. No. 6,996,520 Language translation system and method using specialized dictionaries—Levin Feb. 7, 2006

U.S. Pat. No. 6,993,472 Method, apparatus, and program for chaining machine translation engines to control error propagation—Redpath Jan. 31, 2006

U.S. Pat. No. 6,986,104 Method and apparatus for normalizing and converting structured content—Green, et al. Jan. 10, 2006

U.S. Pat. No. 6,901,367 Front end translation mechanism for received communication—Berstis, et al. May 31, 2005

U.S. Pat. No. 6,857,022 Translation ordering system—Scanlan Feb. 15, 2005

U.S. Pat. No. 6,578,192 Method and system for supporting dynamic document content expressed in a component-level language—Boehme, et al. Jun. 10, 2003

U.S. Pat. No. 6,442,524 Analyzing inflectional morphology in a spoken language translation system—Ecker, et al. Aug. 27, 2002

U.S. Pat. No. 6,434,518 Language translator—Glenn Aug. 13, 2002

U.S. Pat. No. 6,385,586 Speech recognition text-based language conversion and text-to-speech in a client-server configuration to enable language translation devices—Dietz May 7, 2002

U.S. Pat. No. 6,377,928 Voice recognition for animated agent-based navigation—Saxena, et al. Apr. 23, 2002

U.S. Pat. No. 6,356,865 Method and apparatus for performing spoken language translation—Franz, et al. Mar. 12, 2002

U.S. Pat. No. 6,349,276 Multilingual information retrieval with a transfer corpus—McCarley Feb. 19, 2002

U.S. Pat. No. 6,339,410 Apparatus and method for language translation between patient and caregiver, and for communication with speech deficient patients—Milner, et al. Jan. 15, 2002

U.S. Pat. No. 6,338,033 System and method for network-based teletranslation from one natural language to another—Bourbonnais, et al. Jan. 8, 2002

U.S. Pat. No. 6,282,507 Method and apparatus for interactive source language expression recognition and alternative hypothesis presentation and selection—Horiguchi, et al. Aug. 28, 2001

U.S. Pat. No. 6,278,968 Method and apparatus for adaptive speech recognition hypothesis construction and selection in a spoken language translation system—Franz, et al. Aug. 21, 2001

U.S. Pat. No. 6,266,642 Method and portable apparatus for performing spoken language translation Franz, et al. Jul. 24, 2001

U.S. Pat. No. 6,243,669 Method and apparatus for providing syntactic analysis and data structure for translation knowledge in example-based language translation—Horiguchi, et al. Jun. 5, 2001

U.S. Pat. No. 6,223,150 Method and apparatus for parsing in a spoken language translation system—Duan, et al. Apr. 24, 2001

U.S. Pat. No. 5,805,832 System for parametric text to text language translation—Brown, et al. Sep. 8, 1998

U.S. Pat. No. 5,794,178 Visualization of information using graphical representations of context vector based relationships and attributes—Caid, et al. Aug. 11, 1998

U.S. Pat. No. 5,768,603 Method and system for natural language translation—Brown, et al. Jun. 16, 1998

U.S. Pat. No. 5,619,709 System and method of context vector generation and retrieval—Caid, et al. Apr. 8, 1997

U.S. Pat. No. 5,608,623 Special cooccurrence processing method and apparatus—Sata, et al. Mar. 4, 1997

U.S. Pat. No. 5,600,579 Hardware simulation and design verification system and method—Steinmetz, Jr. Feb. 4, 1997

U.S. Pat. No. 5,535,120 Machine translation and telecommunications system using user ID data to select dictionaries—Chong, et al. Jul. 9, 1996

U.S. Pat. No. 5,510,981 Language translation apparatus and method using context-based translation models—Berger, et al. Apr. 23, 1996

U.S. Pat. No. 5,497,319 Machine translation and telecommunications system—Chong, et al. Mar. 5, 1996

U.S. Pat. No. 5,477,451 Method and system for natural language translation—Brown, et al. Dec. 19, 1995

U.S. Pat. No. 5,175,684 Automatic text translation and routing system—Chong Dec. 29, 1992

U.S. Pat. No. 4,688,189 Electronic equipment for storing number of searches of information—Hirata Aug. 18, 1987

U.S. Pat. No. 4,631,748 Electronic handheld translator having miniature electronic speech synthesis chip—Breedlove, et al. Dec. 23, 1986

(2)—Other References Cited:

Search Engine Dictionary.com, A Complete Guide to Search Engine Terminology” (See: www.SearchEngineDictionary.com).

Compendium of Translation Software (Directory of Commercial Machine Translation Systems and Computer-Aided Support Tools), published Online by EMAT, European Association for Machine Translation, located at http://ourworld.compuserve.com/homepages/WJHutchins/Compendium-11.pdf

Adaptive Technology Resource Center, University of Toronto, see: http://www.utoronto.ca/atrc/reference/tech/voicerecog.html

PC Magazine, Jan. 24, 2006, “IBM Strives For Superhuman Speech Tech”, see: http://www.pcmag.com/article2/0,1895,1915071,00.asp

Wikipedia, the free encyclopedia, see: section entitled “Speech synthesis” http://en.wikipedia.org/wiki/Speech_synthesis#Synthesizer

What is claimed is:

1. A method of utilizing more than two bidirectional Machine Translation “Language Pairs” to create a “Community of Language Pairs” (The Community) that consists of one “Language Pair” for every possible bi-directional combination of every two languages and/or language dialects included in The Community thus enabling any-directional machine translation of thee or more languages included in The Community comprising the steps of:
Selecting the individual languages to be included in The Community, wherein said individual languages may include dialects of the same languages (e.g., English) which dialects are different enough, one from the other, so that building different translation language pairs for said dialect is justifiable for the purpose of accuracy of translation (e.g., American English, UK English, South African English, Irish English, Australian English, Indian English, etc).
Once the individual languages to be included in The Community have been selected, the bidirectional translation languages pairs required for The Community are then determined by selecting one “Language Pair” for every possible directional combination of every two individual languages included in The Community.

2. The method of claim 1, wherein the computing system application utilized for said machine translation contains a record of each application user's “language of preference”, which may be said application user's native language or other language in which said application user is fluent. Said record of each application user's language of preference is used to determine the specific bidirectional language pairs required for the application user in order to enable said user to both provide input to and receive output from the machine translation process in said user's language of preference.

3. The method of claim 1, wherein the input to the and output from machine translation process may consist of language text that is electronically recorded in different languages included in The Community, as well as real time interactive communication with and among multiple users whose native language, or other language in which each user is fluent, is included in The Community.

4. The method of claim 3, wherein the electronically recorded language text input to and/or output from the translation process may reside on any device or system which is electronic recording enabled including but not limited to electronic storage media of any kind, a computing enabled device, a database, a network server, or other server environment including but not limited to a private network server, a public network server, database provider server, a telecommunications provider server, a 3G or other communications or content provider server, the Internet, or telephony enabled network of any kind.

5. The method of claim 3, wherein said real time interactive communication with and among multiple users whose native language, or other language in which each user is fluent, is included in The Community employs an electronically enabled communications system of any kind, including but not limited to a server of any kind, the Internet or telephony enabled network and/or device.

6. The method of claim 3, wherein the various computing system applications that utilize said machine translation may receive electronically recorded language text input which is generated by a voice recognition system and/or may produce voice synthesized output which is generated from the electronically recorded machine translation text output.

7. The method of claim 3, wherein the various computing system applications that utilize said machine translation include Multi-Lingual Database Search applications.

8. The method of claim 3, wherein the various computing system applications that utilize said machine translation include Multi-Lingual Internet Search applications.

9. The method of claim 3, wherein the various computing system applications that utilize said machine translation include translation systems and on-line translation services which translate electronic documents, Internet search results, web site contents, and e-mail contents.

10. The method of claim 3, wherein the various computing system applications that utilize said machine translation includes the Internet based real time interactive communications application known as a “Chat Room” or “Interactive Chat”, in all its forms and permutations.

11. The method of claim 3, wherein the various computing system applications that utilize said machine translation includes, the telephony network based real time interactive communications application known as SMS (Short Message Service) used on either a mobile communication device, such as a mobile telephone, or a stationary communications device, such as a computer terminal.

12. The method of claim 3, wherein the various computing system applications that utilize said machine translation includes, the telephony network and/or internet based VOIP application known as the “Voice Auto-Translated Telephone Call”, as disclosed in USPTO provisional patent application entitled “System Design and Module Specifications required to enable a complete and viable Auto-Translation Telephony System”, application No. 60/986,601 filed on Nov. 9, 2007.
